(19) United States
(12) Patent Application Publication
(10) Pub. No.: US 2017/0124280 A1
(43) Pub. Date: May 4, 2017

(54) DETERMINING A CLASS TYPE OF A SAMPLE BY CLUSTERING LOCALLY OPTIMAL MODEL PARAMETERS

(71) Applicant: Wisconsin Alumni Research Foundation, Madison, WI (US)

(72) Inventors: Amos Ron, Madison, WI (US); Shengnan Wang, Madison, WI (US)

(21) Appl. No.: 15/333,888

(22) Filed: Oct. 25, 2016

Related U.S. Application Data
(60) Provisional application No. 62/247,558, filed on Oct. 28, 2015.

(51) Int. Cl. G06F 19/00; G06F 17/16; G06F 17/14

(52) U.S. Cl. CPC G06F 19/3437; G06F 17/14; G06F 17/16

(57) ABSTRACT

A method for characterizing a sample includes acquiring a trace signal for the sample. A set of configurations is generated for defining modeling signals to model the trace signal. Each modeling signal is defined by a plurality of model parameters, and each configuration represents an associated modeling signal having a locally optimal score for fitting the trace signal. A classification cluster is defined in a parameter domain defined by the plurality of model parameters. The classification cluster has an associated class type. The sample is determined to have the class type associated with the classification cluster responsive to determining that at least one of the configurations in the set has a distance from the classification cluster less than a threshold.

This invention was made with government support under 0914986 awarded by the National Science Foundation. The government has certain rights in the invention.

### BACKGROUND

Field of the Disclosure

The present disclosure relates generally to characterizing a sample, and, more particularly, to determining a class type of a sample by clustering locally optimal model parameters.

Description of the Related Art

The classification of different histological cell types in the human body is important for a variety of biological and health-related applications. For example, for the identification of malignant cells. The medical diagnosis that is required for most treatment protocols of cancer is known as histopathology. First, a tissue sample is acquired via surgery, biopsy or autopsy. The tissue is then sliced into multiple thin layers, each of which is placed in a fixative to prevent decay. Different slices of the sample are subsequently stained with different chemicals, each of which is known to reveal certain cellular components. The most common staining technique is Hematoxylin and Eosin (H&E). An expert, such as a pathologist, would then examine the stained slices and report histological findings and conclusions accordingly. Histopathology may be complemented by other methods, for example, blood tests.

Microscopy images, enhanced by contrast agents or stain, are limited to a spatial variation in optical properties, and, once stained, the tissue slice is unusable for any future purpose. Moreover, the accuracy of the results depends greatly on the skill and experience level of the individual reviewing the sample.

While many of the medical analysis techniques are still manual, it is of high interest among biomedical researchers to automate the procedure of identifying the major histological cell types within a body tissue, e.g., breast tissue, identification that is important for example in cancer diagnosis. Fourier Transform Infrared (FTIR) spectroscopy is one acquisition technique for gathering histological data. In FTIR analysis, a sample slice is prepared, but is not stained. Once the sample is placed in the FTIR system, a beam of infrared (IR) is passed through the entire local area of the sample. The beam that is collected as it exits the sample is different from the input one, as some of the energy is absorbed by the chemical components present locally in the sample. The raw FTIR data consist of a 3D dataset, where each pixel in the 2D tissue is associated with a signal that registers, at every frequency, or as used interchangeably, wave number, of the IR beam the amount of energy that was absorbed. This information is collected from every local area (pixel) in the biopsy, and the data are analyzed to glean pertinent information from the biopsy, such as tissue types or chemical composition.

One issue with using FTIR spectroscopy in cancer diagnosis is signal contamination. This is typically caused by jitter, scattering effects, water vapors, and more. Current research methods carry out signal pre-processing to try to correct the contamination. Prevailing preprocessing techniques include dimension reduction (typically via MNF) and baseline adjustment.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a simplified block diagram of a diagnostic system in accordance with some embodiments.

FIG. 2 is a flow diagram illustrating a method for determining a class type of a sample in accordance with some embodiments.

FIG. 3 is a diagram illustrating an FTIR data set associated with multiple pixels in a tissue sample in accordance with some embodiments.

FIG. 4 is a diagram illustrating an example absorption rate trace signal for a given pixel in accordance with some embodiments.

FIG. 5 is a diagram illustrating multiple model signal configurations for a given trace signal in accordance with some embodiments.

FIG. 6 is a flow diagram illustrating a method for identifying malignant tissue in a tissue sample in accordance with some embodiments.

### DETAILED DESCRIPTION

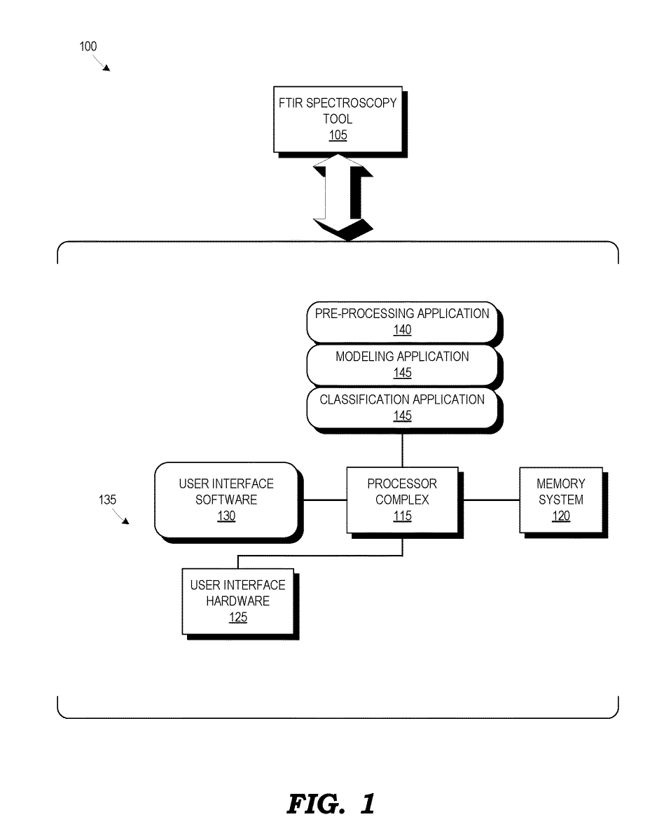

FIGS. 1-6 illustrate example techniques for identifying a class type of a sample, such as a tissue sample. In the illustrated example, the class type of the sample is the presence of malignant cancer cells, such as ductal carcinoma cells. A trace signal is acquired from a sample and is modeled using a model having a plurality of model parameters. For each trace signal, one or more sets of model parameters are generated. Each set of model parameters is used to define a modeling signal for the trace signal. Each such set of model parameters is locally optimal in the sense that its modeling signal represents a local maximum (or minimum) in an underlying model fitting setup. The sets of model parameters are partitioned in the parameter space (e.g., as vectors) to one or more classification clusters, where each classification cluster may have an associated class type. A classification cluster may be represented by an ellipsoid in the parameter space. By determining that one or more of the sets of model parameters for the trace signal is close to or within the ellipsoid, the sample may be classified as having the class type associated with the cluster, such as the sample being a malignant tissue.

FIG. 1 is a simplified block diagram of a diagnostic system 100 including a Fourier Transform Infrared (FTIR) spectroscopy tool 105 and a computing system 110. The computing system 110 may be implemented in virtually any type of electronic computing device, desktop computer, a server, a minicomputer, a mainframe computer, or a supercomputer. The present subject matter is not limited by the particular implementation of the computing system 110. The computing system 110 includes a processor complex 115 communicating with a memory system 120. The memory system 120 may include nonvolatile memory (e.g., hard disk, flash memory, etc.), volatile memory (e.g., DRAM, SRAM, etc.), or a combination thereof. The processor complex 115 may be any suitable processor known in the art, and may represent multiple interconnected processors in one or more housings or distributed across multiple networked locations. The computing system 110 may include user interface hardware 125 (e.g., keyboard, mouse, display, etc.), which together, along with associated user interface software 130 comprise a user interface 135.

The processor complex 115 executes software instructions stored in the memory system 120 and stores results of the instructions on the memory system 120 to implement a pre-processing application 140, a modeling application 145, and a classification application 150, as described in greater detail below.

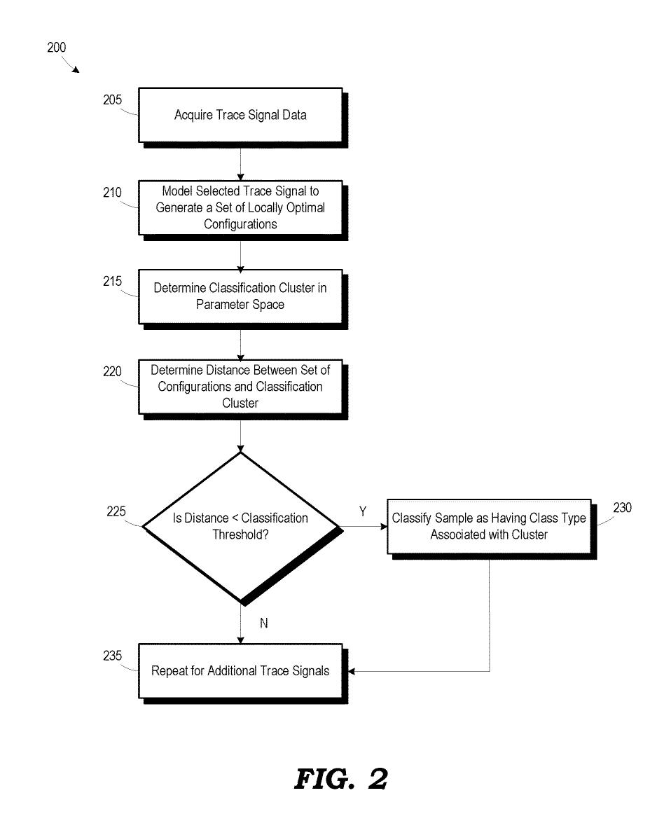

FIG. 2 is a flow diagram illustrating a method 200 for determining a class type of a sample in accordance with some embodiments. In the illustrative example the class type is the presence of malignant cancer cells (e.g., ductal carcinoma) in a tissue sample, however, the techniques described herein are not so limited, and the general modeling and clustering techniques may be applied to other types of samples for detecting other class types.

In method block 200, trace signal data is acquired. Acquiring the trace signal data may include collecting the trace signal data using the FTIR spectroscopy tool 105, retrieving the trace signal from a data storage device, or receiving the trace signal data over a networked data connection. In some embodiments, the trace signal data represents FTIR energy absorption data for a tissue sample. The tissue sample represents a two dimensional array of pixels. The larger set of trace signal data represents an energy absorption spectrum for each pixel that spans a plurality of frequencies (1/s or Hz), which may also be represented as wave numbers (1/cm). For ease of illustration, the following examples employ wave numbers or spectrum index numbers. For example, the full spectrum may contain 1506 entries. The wave number corresponding to the k^{th} entry is approximately 2 k+875.

A separate trace signal (absorption spectrum) is generated for each pixel, each pixel representing a discrete region of the tissue sample illuminated by the FTIR spectroscopy tool 105. The size of each pixel is dependent on the resolution of the FTIR spectroscopy tool 105 (e.g., about 1.1 μm).

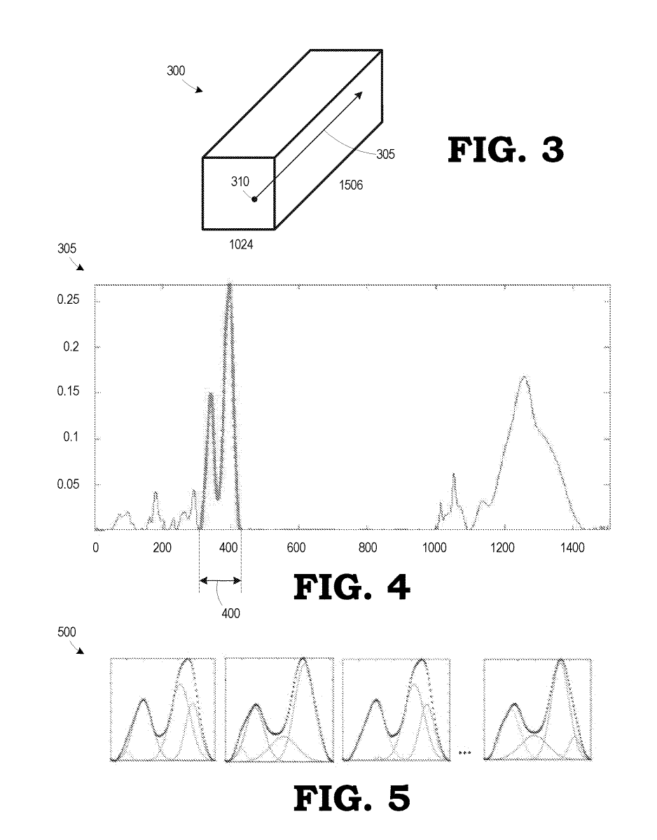

FIG. 3 illustrates the trace signal data set, which is represented by a data cube 300. In the illustrated embodiment, the data cube 300 includes a block of 1024×1024 pixels, and each trace signal curve 305 for a given pixel 310 is 1506 data points deep, each data point representing energy absorption at a particular wavelength. FIG. 4 illustrates an example trace signal curve 305 showing an energy absorption spectrum for a given pixel.

In method block 205, pre-processing is optionally performed (e.g., by the pre-processing application 140 of FIG. 1) on the trace signal data. The particular pre-processing techniques employed may vary, and may include creating a snapshot of the traces signal data (e.g., averaging and downsampling—horizontally and vertically), removing noise (e.g., convolution with a low pass filter using Fourier domain thresholding), removing baseline artifacts (e.g., updating zero absorbance band locations and/or cubic spline interpolation), and extracting a subset of the data. Particular techniques for performing the pre-processing are known to those of ordinary skill in the art, and they are not described in detail herein.

The example trace signal curve 305 illustrated in FIG. 4 represents pre-processed data, prior to extracting the subset. In one embodiment, a subset of the trace signal curve 305 of a particular nature is analyzed. This subset may be referred to as the amide I-II region 400 (or alternatively, the protein band), which includes two characteristic peaks. The region 400 generally represents the portion of the signal associated with spectrum index numbers 302-435, or wave numbers 1479-1745. If only the protein band data points are used, they may be represented as protein band index numbers 1-133, and the conversion to wave number is given by approximately 2 k+1479. In some embodiments, the FTIR spectroscopy tool 105 may be configured to collect only data from the region 400 by limiting the range of frequencies applied to the sample. As a result, the data extraction would not be necessary and the pre-processing techniques may vary accordingly.

In method block 210, the trace signal curve 305 is modeled (e.g., by the modeling application 145 of FIG. 1) to generate a set of configurations, where each configuration is a set of model parameters whose model signal is locally optimal. In the illustrated embodiment, a Gaussian mixture (GM) is employed to model each trace signal curve 305. The application of the present subject matter is not limited to a Gaussian mixture modeling approach, as other types of models may be used. In some embodiments, the Gaussian mixture includes four Gaussian components each having its own covariance matrix (i.e., variable tension). A parameter domain, Θ, is defined for the Gaussian mixture. Each GM component has a magnitude component, ωᵢ, a mean component, μᵢ, and a standard deviation component, σᵢ. The parameter space is thus defined by the 12 model parameters Θ⊂R¹². Each set θ∈Θ of model parameters generates a modeling signal, g_{θ}, in the signal domain (i.e., the same domain as the trace signal curve, f, of a given pixel in a given tissue). In the present illustration, the model signal is a GM with four components. Some of the modeling signals, g_{θ}, poorly represent the underlying f, while others match better.

In principle, since Θ is small compared to the signal domain, a perfect match is unlikely. A score, L(f,g_{θ}), is associated with the modeling signal, g_{θ}. The scoring is applied to a normalized Gaussian mixture:

$${\sum }_{k} {g}_{θ} ( k ) = 1.$$

The score that determines the fit between the model signal and the trace signal for a particular set of parameters is the log-likelihood of g_{θ}:

$${L}_{f} ( θ ) = {\sum }_{k} f ( k ) log {g}_{θ} ( k ) .$$

A scoring map may be defined for the sets of model parameters:

L_{f}:Θ→R₊,θ→L(f,g_{θ}).

The map L_{f} represents a parameter domain transformation of the original trace signal curve, f. Techniques for determining the model parameters to model the signal, f, are known in the art, and they are not described in detail herein. For example, an expectation-maximization (EM) algorithm may be employed. Conventional modeling approaches attempt to find the one set of model parameters θ_{OPT} that represents the global maximum of the scoring function, or the optimal solution. Sets of model parameters that score less than the global maximum are discarded. Rather than determining only the global maximum set of model parameters, the modeling technique employed herein determines all the locally optimal sets of model parameters.

To generate a set of locally optimal model parameters, a pseudo random seed of model parameters is selected, θ⁰∈Θ. An optimization process is performed until the model parameters converge to a local optimal value, θ*, where local perturbation of the parameters does not lead to an improved score representing the fit between the model signal and the trace signal. A locally optimal set of model parameters is referred to herein as a configuration, as the set of associated model parameters define the configuration of the modeling signal. A configuration is a parameter domain representation of the trace signal, f. The process is repeated with initial seeds that are selected pseudo-randomly over the entire parameter domain to generate additional configurations. In the illustrated embodiment, 250 random seeds are employed to generate 250 possible configurations. Some seeds will converge to the same configuration, so duplicate configurations may be identified. In some embodiments described below, a screening process may be employed using a reduced set of seeds. If initial screening thresholds are met, the full set may be used.

The resulting sets of locally optimal configurations represent a transformation of the signal, f, into a likelihood-based infrared Fourier transform (LIFT) representation using the sequence:

Config(f)=(θ₁, θ₂, θ₃, . . . )

FIG. 5 is a diagram illustrating an example pixel trace signal, f, and a set of four locally optimal configurations 500 for modeling the signal. Rather than listing the 12 model parameters for each configuration, the Figure shows the four Gaussians whose sum is the locally optimal modeling signal g.

Table 1 illustrates a GM configuration portfolio for 3 pixels with random initializations. The parameter, p, in Table 1 represents the number of times that the particular configuration was observed across the 250 initialization seeds.

TABLE 1
Four-Gaussian mixture configuration portfolio of 3 pixels with random initializations

| ω1 | μ1 | σ1 | ω2 | μ2 | σ2 | ω3 | μ3 | σ3 | ω4 | μ4 | σ4 | |
|---|---|---|---|---|---|---|---|---|---|---|---|---|
| P1 | P2 | P3 | P4 | P5 | P6 | P7 | P8 | P9 | P10 | P11 | P12 | ρ |
| 0.098 | 33.62 | 10.96 | 0.034 | 76.51 | 13.22 | 0.18 | 92.27 | 9.77 | 0.033 | 109.04 | 5.41 | 180 |
| 0.019 | 18.35 | 4.95 | 0.096 | 34.74 | 9.97 | 0.023 | 73.07 | 14.75 | 0.189 | 93.06 | 11.04 | 70 |
| 0.116 | 34.75 | 10.74 | 0.194 | 88.86 | 9.67 | 0.118 | 98.65 | 7.31 | 0.045 | 110.72 | 5.03 | 120 |
| 0.007 | 27.47 | 8.22 | 0.044 | 38.14 | 4.88 | 0.050 | 43.03 | 8.72 | 0.270 | 93.36 | 11.01 | 28 |
| 0.013 | 18.88 | 4.24 | 0.115 | 35.46 | 10.35 | 0.259 | 91.91 | 10.35 | 0.046 | 107.25 | 6.09 | 85 |
| 0.025 | 20.55 | 5.15 | 0.080 | 35.83 | 8.29 | 0.038 | 37.28 | 12.24 | 0.270 | 93.39 | 10.97 | 13 |
| 0.023 | 22.08 | 5.62 | 0.089 | 36.05 | 10.78 | 0.029 | 37.16 | 5.27 | 0.270 | 93.37 | 11.00 | 2 |
| 0.014 | 19.73 | 4.57 | 0.110 | 35.38 | 10.46 | 0.012 | 38.90 | 2.73 | 0.270 | 93.35 | 11.01 | 1 |
| 0.112 | 34.63 | 10.86 | 0.013 | 39.48 | 2.55 | 0.259 | 91.91 | 10.33 | 0.047 | 107.28 | 6.09 | 1 |
| 0.138 | 38.49 | 11.28 | 0.215 | 87.90 | 10.55 | 0.139 | 100.26 | 7.05 | 0.033 | 112.87 | 4.38 | 17 |
| 0.139 | 38.32 | 11.13 | 0.011 | 65.54 | 4.47 | 0.230 | 88.47 | 10.07 | 0.132 | 102.55 | 7.99 | 32 |
| 0.132 | 37.67 | 10.74 | 0.012 | 57.31 | 18.70 | 0.231 | 89.13 | 10.30 | 0.120 | 102.81 | 7.84 | 181 |
| 0.139 | 38.26 | 11.10 | 0.076 | 82.17 | 10.84 | 0.204 | 92.34 | 9.32 | 0.095 | 104.69 | 7.30 | 3 |
| 0.133 | 38.41 | 11.43 | 0.015 | 41.07 | 2.87 | 0.222 | 88.65 | 10.86 | 0.123 | 101.93 | 8.10 | 3 |
| 0.033 | 23.23 | 5.44 | 0.128 | 39.08 | 8.44 | 0.023 | 56.82 | 20.17 | 0.288 | 93.32 | 11.25 | 12 |
| 0.010 | 20.75 | 3.89 | 0.138 | 38.87 | 10.97 | 0.220 | 88.59 | 10.91 | 0.124 | 101.81 | 8.14 | 2 |

It has been determined that samples with different class types result in different types of configurations. Heuristically, each configuration is a feature of the signal, f. At present, the actual likelihood score for each configuration is not used for diagnostic purposes. It has been determined that each configuration is a potentially valuable feature, because the score it provides cannot be improved by local perturbation of the parameters, and thus, it may include some information about the sample.

To classify the sample (e.g., the pixel), the parameter space representations of the trace signal defined by the configurations are evaluated to determine if any of the configurations has parameters that reside in predetermined regions of the parameter space. Based on empirical observation, these regions may be defined to identify one or more class types (e.g., tissue types) for the sample. Such regions may be defined as classification clusters.

In method block 215, at least one classification cluster is defined. This determination may be performed in advance of the acquisition or processing of the signal trace data. A basic characteristic of the output of LIFT is that the totality of all the configurations that are produced from different pixels (in the same subtissue, from different subtissues of the same biopsy, from different biopsies of the same subject, or from different subjects), occupy only a small subset of the parameter space defined by the model parameters. Moreover, this small subset is the union of a few compact regions, each of which may have the shape of a small ellipsoid. Each such compact region is defined as an empirical cluster, and the empirical clusters are enumerated. Each empirical cluster defines a class type. Each configuration that is produced by LIFT falls inside one of the empirical clusters, and thereby inherits the class type of that cluster. Using this approach, configurations may be classified by the class type. Configurations in a particular class type may be found in different tissue types. Examples of tissue types include epithelium, stroma, necrosis, or carcinoma epithelium. Other class types may have their configuration appear only in the pixels of one specific tissue type.

In a case where different tissue types contribute to the same empirical cluster, that cluster may render little diagnostic value. However, it has been noted that some empirical clusters are only associated with samples having a particular class type. For example, one or more clusters in the parameter space may be associated with tissue samples having malignant cells, such as ductal carcinoma. Hence, if a particular tissue sample includes one or more configurations that fall within such a cluster, a diagnostic decision may be made to classify the tissue sample as being malignant.

A classification cluster, C, may be defined that encloses an empirical cluster. In some embodiments, the classification cluster may be defined by an ellipsoid. In other embodiments, box conditions may be employed. An empirical cluster is somewhat qualitative. The empirical cluster includes some degree of variation that is dependent on factors, such as the particular patient used to identify the cluster and the FTIR acquisition environment. In actuality, each patient has a unique empirical cluster in the parameter space that represents malignant cells in that patient. However, the unique clusters for different patients do overlap, so a thresholding technique may be employed to account for the variation between the tissue sample being classified and the empirical clustering data that were used to identify the classification clusters.

To define the approximate shape of an empirical cluster, and thereby generate a classification cluster, a singular value decomposition (SVD) approach is employed. Particular parameters for example classification clusters employed to detect malignant tissue are described in greater detail below.

An ellipsoid defining a classification cluster has 12 dimensions corresponding to the 12 model parameters, Θ⊂R¹². To allow the comparison between a particular configuration and a classification cluster, the classification cluster is defined using singular value decomposition (SVD) coordinates.

Consider a cluster C⊂Θ, wherein a mean of C (i.e., the centroid of the classification cluster) is μ∈Θ. The mean is subtracted from the classification cluster to obtain:

C⁰:=C−μ.

The singular value decomposition of C⁰ is calculated and normalized by the singular vector values associated with the cluster (i.e., the boundaries of the cluster) to obtain a matrix:

U:=U(C).

Techniques for generating the SVD representation of a cluster C are known to those of ordinary skill in the art, and they are not described in greater detail herein. The singular vectors define the direction of the ellipsoid axes, while the singular values provide an estimate for the length of each axis. After subtracting the mean, the singular values are used to scale the singular vectors to generate the SVD vector representation of the classification cluster. The long axis in the SVD representation corresponds to short axis in the cluster and vice versa.

In method block 220, a distance between the configurations for a given pixel and one or more classification clusters is determined (e.g., by the classification application 145 of FIG. 1). Given a configuration θ⊂Θ, the C-based SVD local coordinates are:

U′(θ−μ),

where the columns of U are the scaled singular vectors.

The distance between a given configuration and the cluster using a 2-norm calculation is:

d_{C}(θ):=∥U′(θ−μ)∥₂.

The minimum distance across all of the configurations associated with a given pixel is the distance from the pixel to the classification cluster:

d_{C}(c):=min(d_{C}(θᵢ)).

In method block 225, the calculated distance is compared to a classification threshold. The threshold attempts to address the inherent qualitative nature and variation associated with an empirical cluster. If the distance is less than the classification threshold for a given configuration in method block 225, the associated sample is classified as having a class type associated with the classification cluster in method block 230. In method block 235, the process is repeated for additional trace signals (e.g., pixels).

The determining of the distance and comparing the distance to a threshold is one example technique for determining proximity between the configuration and the cluster. However, is some embodiments, a different proximity detection technique may be employed, depending on factors such as the shape of the cluster.

Although FIG. 2 illustrates the use of a single classification cluster, in some embodiments, one or more classification clusters may be employed. The evaluations in method blocks 220, 225, and 230 may be repeated for additional classification clusters. Techniques that employ all the classification clusters in a single classification step may be used in lieu of the separate processing of each classification cluster.

Due to the size of the FTIR data set, it is computationally demanding to generate the set of configurations for each pixel for a full set of random seeds (e.g., 250). In some embodiments, a screening process may be employed to reduce the computational demands. During the training process, an empirical cluster was identified that was indicative, but not dispositive, of the presence of malignant tissue. A screening cluster was defined for this empirical cluster. It was generally the case that malignant tissue samples resulted in configurations proximate the screening cluster. However, the screening cluster was not dispositive, because other types of tissue also resulted in configurations that were proximate the screening cluster. The malignant tissue also tended to result in configurations that were proximate other clusters (detailed below) that were dispositive of the presence of cancer. To reduce the computational complexity, a reduced number of random seeds (e.g., four) was employed to screen the pixel. If one of the four resulting configurations fell within the screening cluster, the modeling was iterated over the full set of 250 seeds.

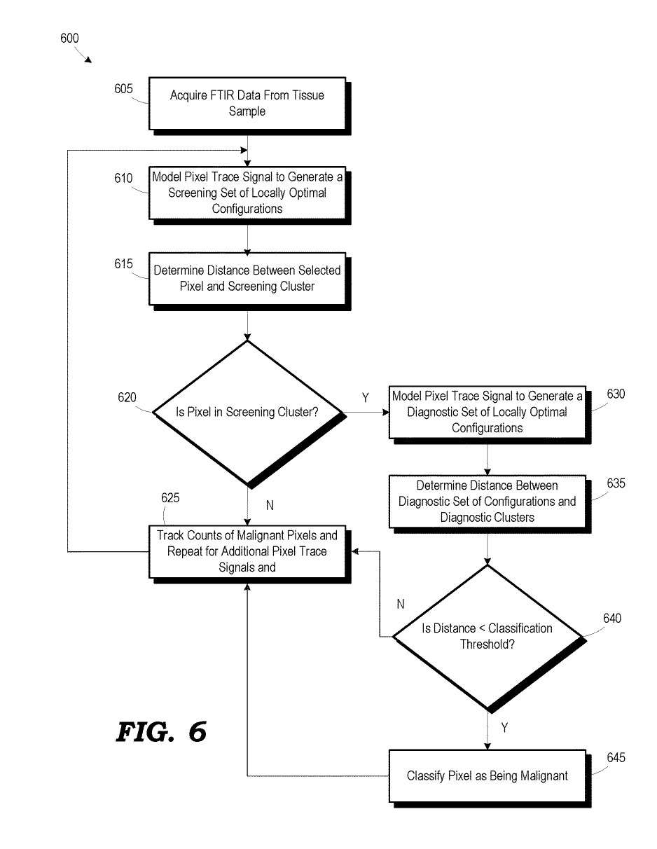

FIG. 6 is a flow diagram illustrating a method 600 for identifying malignant tissue in a tissue sample in accordance with some embodiments. The computational techniques described above in reference to FIG. 2 may be employed to model the FTIR data to generate configurations and to evaluate clusters. In method block 605, FTIR data are acquired from a tissue sample. Acquiring the FTIR data may include collecting the data using the FTIR spectroscopy tool 105, retrieving the FTIR data from a data storage device, or receiving the FTIR data over a networked data connection. Pre-processing may be performed on the acquired FTIR data, as described above. In the method 600, two types of classification clusters are employed, a screening cluster (indicative, but not dispositive), and two diagnostic clusters (dispositive).

In method block 610, the trace signal data for a given pixel is modeled using a reduced number of random seeds (e.g., four) to generate a screening set of locally optimal configurations. In method block 615, it is determined if a given pixel is within the screening cluster. In some embodiments, a box condition may be used to define the screening cluster, as opposed to using SVD coordinates. An exemplary set of box conditions for the screening cluster using wave numbers is:
1548<P5<1557 &
9<P5<14&
1524<P2<1534 &
P8>1612,
   where PX represents the model parameter, as illustrated above in Table 1. Model parameters P2, P5, and P8 are the means of the 1^{st}, 2^{nd}, and 3^{rd} Gaussians, and P6 is the standard deviation of the 2^{nd} Gaussian. Note that only a reduced set of model parameters is employed with the box conditions of the screening cluster, thereby simplifying the calculation. In other embodiments, an ellipsoid may be defined for the screening cluster in SVD coordinates and a distance may be calculated, as described above.

If the pixel does not have an associated configuration within the screening cluster in method block 620, the screening process is repeated in method block 625 for additional pixel trace signals by returning to method block 610 for a new pixel.

If the pixel does have an associated configuration within the screening cluster in method block 620, a full set of random seeds is employed to generate a diagnostic set of locally optimal configurations for the pixel trace signal in method block 630 (e.g., 250 minus the number used to generate the screening set). The configurations determined in the screening set may be added to the additional configurations determined in method block 630.

In method block 635, the distance between the diagnostic set of configurations and one or more diagnostic clusters is determined. In the illustrated embodiment, two diagnostic clusters are employed. It has been determined that about 10-30% of malignant pixels result in configurations that appear in the first diagnostic cluster and about 10-20% of malignant pixels result in configurations that appear in the second diagnostic cluster. Thus, the presence of cancer is detected based on a relatively small subset of the malignant pixels.

Example values for the centroids of the screening cluster and the diagnostic clusters are illustrated in Table 2. The values are expressed in spectrum index numbers. To convert the standard deviation to wave numbers, they may be multiplied by 2. To convert the means to wave numbers, they may be multiplied by 2 and increased by 1479 (they are represented by protein band index values in Table 2). As described above, these values are dependent on the particular patient used to generate the clusters and the FTIR acquisition environment. The variation due to these affects may be addressed by selecting thresholds for the screening cluster and the diagnostic clusters (e.g., box conditions or distance thresholds).

TABLE 2
Centroids of Screening and Diagnostic Clusters

| | ω1 | μ1 | σ1 | ω2 | μ2 | σ2 | ω3 | μ3 | σ3 | ω4 | μ4 | σ4 |
|---|---|---|---|---|---|---|---|---|---|---|---|---|
| Type | P1 | P2 | P3 | P4 | P5 | P6 | P7 | P8 | P9 | P10 | P11 | P12 |
| SC | 0.040 | 26.030 | 7.950 | 0.050 | 38.420 | 6.260 | 0.097 | 86.700 | 7.860 | 0.090 | 100.200 | 8.020 |
| DC1 | 0.021 | 25.210 | 7.820 | 0.021 | 26.680 | 7.990 | 0.052 | 38.440 | 6.210 | 0.148 | 93.260 | 10.430 |
| DC2 | 0.030 | 23.700 | 7.360 | 0.001 | 26.370 | 3.050 | 0.057 | 37.480 | 6.540 | 0.143 | 93.070 | 10.470 |

To determine the distance between the configurations of a selected pixel and the diagnostic clusters, the centroid of the diagnostic cluster is subtracted from the configurations in the diagnostic set.

The mean adjusted configurations are provided in matrix form, with the columns representing the configurations. An inner product is determined between the configuration matrix and the singular vector matrix generated by scaling the diagnostic cluster using the singular values to generate a distance vector. A 2-norm calculation is performed on the distance vector to generate the minimum distance between the configurations vectors and the diagnostic clusters.

Example singular value vector matrices for the diagnostic clusters are provided below in Tables 3 and 4. In the SVD matrix, the 12 parameters (coefficients, mean, standard deviation) can be used to index the rows.

TABLE 3
Singular Value Matrix of Diagnostic Cluster 1

| | | | | | | | | | | | |
|---|---|---|---|---|---|---|---|---|---|---|---|
| 300.728 | 30.568 | 17.916 | 1.445 | 0.059 | 0.036 | −0.010 | −0.009 | −0.006 | 0.005 | −0.001 | 0.001 |
| −0.070 | 0.155 | −0.294 | 0.015 | −0.067 | 0.122 | −0.024 | −0.145 | 0.029 | 0.180 | −0.221 | 0.179 |
| 0.069 | 0.361 | −0.186 | 0.185 | 0.067 | 1.153 | −0.585 | 0.294 | −0.220 | −0.415 | −0.110 | −0.031 |
| 300.224 | 44.434 | −17.204 | 2.132 | −0.013 | −0.058 | 0.024 | 0.014 | 0.003 | −0.006 | 0.000 | −0.001 |
| −0.085 | 0.395 | −0.232 | −0.009 | 0.195 | 0.509 | −0.071 | −0.065 | −0.069 | 0.312 | −0.126 | −0.212 |
| −0.036 | 0.227 | −0.292 | 0.183 | 0.244 | 2.037 | 0.342 | 0.636 | 0.193 | 0.162 | 0.071 | 0.050 |
| −147.969 | 164.646 | 1.438 | 4.515 | 0.036 | −0.027 | 0.001 | 0.005 | −0.004 | 0.002 | 0.000 | 0.000 |
| −1.514 | −0.430 | 0.705 | −0.174 | −0.345 | −1.128 | 0.511 | 0.930 | 0.323 | −0.107 | −0.095 | −0.043 |
| 2.666 | −0.266 | −0.060 | 0.076 | −1.014 | −0.541 | −1.086 | 0.598 | −0.062 | 0.220 | 0.052 | 0.028 |
| −29.087 | −62.911 | 0.308 | 14.023 | 0.146 | −0.070 | 0.011 | 0.015 | −0.016 | 0.004 | 0.000 | 0.000 |
| 0.505 | −0.072 | −0.105 | 0.272 | 0.448 | 0.195 | −0.530 | −0.341 | 0.858 | −0.061 | −0.007 | −0.021 |
| −0.727 | 0.423 | −0.315 | −0.739 | 3.288 | −0.512 | −0.219 | 0.276 | −0.107 | 0.046 | 0.007 | 0.020 |

TABLE 4
Singular Value Matrix of Diagnostic Cluster 2

| | | | | | | | | | | | |
|---|---|---|---|---|---|---|---|---|---|---|---|
| 221.429 | −186.597 | −102.043 | −2.907 | −0.287 | −0.077 | 0.010 | 0.015 | 0.003 | 0.007 | −0.001 | 0.000 |
| 0.468 | 1.617 | 0.955 | 1.457 | −1.503 | −0.849 | −0.535 | −0.178 | 0.157 | −0.035 | 0.058 | −0.134 |
| 1.735 | −3.611 | −3.471 | −3.810 | 5.470 | 1.217 | −0.373 | −0.287 | 0.122 | −0.174 | 0.029 | −0.037 |
| 475.114 | 79.159 | 54.354 | −1.304 | −0.033 | 0.005 | 0.000 | 0.003 | 0.003 | −0.005 | −0.001 | 0.000 |
| 0.552 | 0.238 | 0.047 | −0.150 | 0.464 | 0.056 | −0.239 | −0.351 | −0.076 | 0.454 | −0.358 | −0.021 |
| −1.341 | −0.823 | −0.388 | 0.590 | −0.530 | −0.255 | −1.195 | 0.613 | 0.144 | −0.680 | −0.168 | 0.018 |
| 1.649 | 211.477 | −98.877 | −6.988 | −0.402 | −0.102 | −0.015 | 0.010 | 0.009 | 0.006 | 0.000 | 0.000 |
| −2.141 | 0.703 | 0.240 | −0.535 | −0.193 | 1.269 | 0.717 | 1.523 | −0.129 | 0.098 | −0.038 | −0.046 |
| 1.664 | −0.841 | 0.136 | 0.294 | −0.680 | 0.841 | −1.794 | 0.344 | 0.012 | 0.495 | 0.115 | 0.022 |
| −64.870 | −51.881 | 47.188 | −19.733 | −1.017 | −0.273 | −0.033 | 0.024 | 0.025 | 0.013 | −0.001 | 0.000 |
| 0.715 | 0.025 | −0.190 | −0.569 | 0.329 | −0.211 | −0.362 | −0.113 | −1.107 | −0.145 | 0.020 | −0.013 |
| 1.449 | 0.830 | 0.364 | −0.015 | 3.109 | −2.428 | −0.091 | 0.767 | 0.019 | 0.240 | 0.022 | 0.010 |

In method block 640, the calculated distance is compared to a classification threshold. As described above, the threshold is selected to compensate for the inherent qualitative nature and variation associated with the empirical cluster used in generating the diagnostic clusters. If the distance is less than the classification threshold for a given configuration in method block 640, the associated pixel is classified as having malignant tissue. Again, evaluating distance is considered one example technique for determining proximity.

In method block 625, the process is repeated for additional pixel trace signals. During the iterative process that spans the multiple pixels, the results of the individual pixel classifications may be grouped to allow for a subsequent global classification of the entire tissue sample. For example, a grid may be defined for a particular tissue sample, and a count of malignant pixels may be generated for each grid section. Not all grid sections may include malignant pixels. To classify the overall tissue sample as being malignant, count thresholds may be employed for each grid section and/or for the overall sample.

In some embodiments, a method for characterizing a sample includes acquiring a trace signal for the sample. A set of configurations is generated for defining modeling signals to model the trace signal. Each modeling signal is defined by a plurality of model parameters, and each configuration represents an associated modeling signal having a local maximum score for fitting the trace signal. A classification cluster is defined in a parameter domain defined by the plurality of model parameters. The classification cluster has an associated classification type. The sample is determined to have the classification type associated with the classification cluster responsive to determining that at least one of the configurations in the set is proximate the classification cluster.

In some embodiments, a method for detecting malignancy in a tissue sample includes acquiring a set of Fourier Transform Infrared (FTIR) spectroscopy data for the tissue sample. The FTIR data includes an energy absorption spectrum signal for each of a plurality of pixels. A diagnostic set of configurations is generated for defining modeling signals to model the energy absorption spectrum signal for a selected pixel. Each modeling signal is defined by a plurality of model parameters. Each configuration represents an associated modeling signal and has a local maximum score for fitting the energy absorption spectrum signal. A classification cluster is defined in a parameter domain defined by the plurality of model parameters. It is determined that the selected pixel is associated with malignant tissue responsive to determining that at least one of the configurations in the diagnostic set is proximate the classification cluster. The generating of the diagnostic set of configurations and the determining of the proximity to the classification cluster are repeated for each of the pixels.

In some embodiments, a system includes a memory to store a plurality of instructions and a processor. The processor is to execute the instructions to acquire a trace signal for a sample, generate a set of configurations for defining modeling signals to model the trace signal, wherein each modeling signal is defined by a plurality of model parameters, and each configuration represents an associated modeling signal having a local maximum score for fitting the trace signal, define a classification cluster in a parameter domain defined by the plurality of model parameters, the classification cluster having an associated classification type, and determine that the sample has the classification type associated with the classification cluster responsive to determining that at least one of the configurations in the set is proximate the classification cluster.

In some embodiments, certain aspects of the techniques described herein may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as flash memory, a cache, random access memory (RAM), or other non-volatile memory devices, and the like. The executable instructions stored on the non-transitory computer readable storage medium may be in source code, assembly language code, object code, or other instruction format that is interpreted or otherwise executable by one or more processors.

A non-transitory computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for characterizing a sample, comprising:
acquiring a trace signal for the sample;
generating a set of configurations for defining modeling signals to model the trace signal, wherein each modeling signal is defined by a plurality of model parameters, and each configuration represents an associated modeling signal having a locally optimal score for fitting the trace signal;
defining a classification cluster in a parameter domain defined by the plurality of model parameters, the classification cluster having an associated class type; and
determining that the sample has the class type associated with the classification cluster responsive to determining that at least one of the configurations in the set is proximate the classification cluster.

2. The method of claim 1, wherein the sample comprises a tissue sample, and the class type comprises malignant tissue.

3. The method of claim 2, wherein the class type comprises ductal carcinoma.

4. The method of claim 1, wherein the plurality of model parameters defines a Gaussian mixture.

5. The method of claim 1, wherein the classification cluster comprises an ellipsoid defined in the parameter space.

6. The method of claim 5, wherein the ellipsoid is defined using a singular value decomposition matrix.

7. The method of claim 1, further comprising:
defining a plurality of classification clusters in the parameter domain having the class type; and
determining that the sample has the class type responsive to determining that at least one of the configurations in the set is proximate any of the plurality of classification clusters.

8. The method of claim 1, wherein the trace signal comprises a Fourier Transform Infrared energy absorption spectrum signal.

9. The method of claim 7, wherein the trace signal is associated with one of a plurality of pixels generated for the sample, and the method comprises:
repeating the generating of the set of configurations and the determining that the sample has the class type for each of the plurality of pixels; and
determining a count of pixels having the class type associated with the classification cluster.

10. The method of claim 1, wherein determining that at least one of the configurations in the set is proximate the classification cluster comprises determining that at least one of the configurations in the set has a distance from the classification cluster less than a threshold.

11. A method for detecting malignancy in a tissue sample, comprising:
acquiring a set of Fourier Transform Infrared (FTIR) spectroscopy data for the tissue sample, the FTIR data including an energy absorption spectrum signal for each of a plurality of pixels;
generating a diagnostic set of configurations for defining modeling signals to model the energy absorption spectrum signal for a selected pixel, wherein each modeling signal is defined by a plurality of model parameters, and each configuration represents an associated modeling signal having a locally optimal score for fitting the energy absorption spectrum signal;
defining a classification cluster in a parameter domain defined by the plurality of model parameters;
determining that the selected pixel is associated with malignant tissue responsive to determining that at least one of the configurations in the diagnostic set is proximate the classification cluster; and
repeating the generating of the diagnostic set of configurations and the determining of the proximity to the classification cluster for each of the pixels.

12. The method of claim 11, further comprising classifying the tissue sample as being malignant based on a count of the pixels associated with malignant tissue.

13. The method of claim 11, further comprising:
generating a screening set of configurations for defining modeling signals to model the energy absorption spectrum signal for the selected pixel using a first number of random seeds;
defining a screening cluster in the parameter domain; and
generating the diagnostic set of configurations using a second number of random seeds greater than the first number responsive to determining that at least one of the configurations in the screening set is within the screening cluster.

14. The method of claim 11, wherein the plurality of model parameters defines a Gaussian mixture.

15. The method of claim 11, wherein the diagnostic cluster comprises an ellipsoid defined in the parameter space.

16. The method of claim 15, wherein the ellipsoid is defined using a singular value decomposition matrix.

17. The method of claim 11, further comprising:
defining a plurality of diagnostic clusters in the parameter domain; and
determining that the selected pixel is associated with malignant tissue responsive to determining that at least one of the configurations in the diagnostic set is proximate any of the plurality of diagnostic clusters.

18. The method of claim 11, wherein determining that at least one of the configurations in the set is proximate the classification cluster comprises determining that at least one of the configurations in the diagnostic set has a distance from the classification cluster less than a threshold.

19. A system, comprising:
a memory to store a plurality of instructions; and
a processor to execute the instructions to acquire a trace signal for a sample, generate a set of configurations for defining modeling signals to model the trace signal, wherein each modeling signal is defined by a plurality of model parameters, and each configuration represents an associated modeling signal having a local maximum score for fitting the trace signal, define a classification cluster in a parameter domain defined by the plurality of model parameters, the classification cluster having an associated classification type, and determine that the sample has the classification type associated with the classification cluster responsive to determining that at least one of the configurations in the set is proximate the classification cluster.
